(19) United States
(12) Patent Application Publication
(10) Pub. No.: US 2011/0249547 A1
(43) Pub. Date: Oct. 13, 2011

(54) OPTICAL DISC

(76) Inventors: Shih-Mim CHANG, Xinpu Township (TW); Shing-Tang Liao, Xinpu Township (TW); Chien-Chang Lu, Yangmei Township (TW)

(21) Appl. No.: 12/839,151

(22) Filed: Jul. 19, 2010

(30) Foreign Application Priority Data
Apr. 9, 2010 (TW) 99206325

(51) Int. Cl. G11B 7/26

(52) U.S. Cl. 369/283; G9B/7.186

(57) ABSTRACT

Disclosed herein is an optical disc having an information area situated between an internal edge and an external edge of the optical disc. The optical disc includes a first substrate, a second substrate, a recording layer, a reflecting layer and a number of surface structures. The second substrate is disposed over the second substrate, the recording layer and the reflecting layer are disposed between the two substrates, and the reflecting layer is disposed between the first substrate and the recording layer. The surface structures are discontinuously disposed on the surface of the second substrate.

### RELATED APPLICATIONS

This application claims priority to Taiwan Application Serial Number 99206325, filed Apr. 9, 2010, which is herein incorporated by reference.

### BACKGROUND

1. Field

The present disclosure relates to a storage medium. More particularly, the present disclosure relates to an optical disc.

2. Description of Related Art

Optical storage media is in advantage of convenient storage of data, long keeping time, high compatibility, low probability of mistake in writing and reading, and high resistance to damage. Accordingly, the optical storage media has been widely used to make a backup copy and data reservation in business and home application.

However, optical discs are usually stored in a way that the optical discs are stacked up together. In this way, a printing side of one optical disc may directly contact with a reading side of another one. When a number of optical discs are stacked up, one optical disc may be pressured due to the gravity force of other optical discs disposed thereabove. As a result, the air that originally existed between two adjacent optical discs may be pushed out, and thereby forming a vacuum-liked condition between two adjacent optical discs. Therefore, the two adjacent optical discs are stuck with each other because of the absorption due to the vacuum-liked condition.

When a user grabs the optical discs, the stuck optical discs may lead to an inconvenient usage. Also, in the manufacturing procedure, the stuck optical discs increase the difficulty of grabbing the optical disc by a robot. In addition, when the optical discs are stuck together, the evaporated vapor, generated from the ink formed on the printing side of the optic disc, may disadvantageously influence the quality of the reading side of the adjacent optical disc. Especially, in recent years, the optical disc maker has developed a “printable optical disc” which allows users to print patterns on the surface of the optical disc by themselves. This type of printable optical discs typically has a smooth surface, and rendering the above-mentioned problem more serious.

### SUMMARY

Therefore, according to one aspect of the present disclosure, an improved optical disc is provided to resolve the above-mentioned issue.

The optical disc has an internal edge, an external edge and an information area situated therebetween. The optical disc comprises a first substrate, a second substrate, a recording layer, a reflecting layer, and a plurality of surface structures. The second substrate is disposed above the first substrate. The recording layer is disposed between the first substrate and the second substrate. The reflecting layer is disposed between the first substrate and the recording layer. The plurality of surface structures are discontinuously disposed on the surface of the second substrate.

According to one embodiment of the present disclosure, the information area has an inner boundary and an outer boundary, and the plurality of the surface structures are positioned between the internal edge and the inner boundary.

According to another embodiment of the present disclosure, the information area has an inner boundary and an outer boundary, and the plurality of the surface structures are positioned between the outer boundary and the external edge.

According to still another embodiment of the present disclosure, the information area has an inner boundary and an outer boundary, and the plurality of the surface structures are positioned between the internal edge and the inner boundary, and between the outer boundary and the external edge.

According to one embodiment of the present disclosure, the surface structures comprise a plurality of bumps so as to form a first profile on the surface structures, and wherein a groove is formed between any of the two adjacent bumps.

According to one embodiment of the present disclosure, the surface structures further comprise a plurality of sub-bumps disposed on the plurality of bumps so as to form a second profile on the surface structures. The second profile is more complex than the first profile.

According to one embodiment of the present disclosure, each of the bumps comprises a side edge facing the adjacent groove, and wherein the side edge extends on a radial direction of the optical disc.

According to another embodiment of the present disclosure, each of the bumps comprises a side edge facing the adjacent groove, and wherein the side edge extends on a direction that forms a non-right angle with a radial direction of the optical disc.

According to one embodiment of the present disclosure, each of the bumps extends along a circumferential direction of the optical disc.

According to one embodiment of the present disclosure, each of the bumps protrudes from a surface of the second substrate, and has a height of about 70 μm.

According to one embodiment of the present disclosure, the recording layer comprises a material selected from the group consisting of cyanine dye, azo dye, squarylium dye, formazan dye, and a combination thereof.

According to one embodiment of the present disclosure, the recording layer comprises a material selected from the group consisting of Si, Sn, Al, Ag, Au, Ti, Ni, Cu, Co, Ta, Fe, W, Cr, V, Ga, Pb, Mo, Sb, In, Bi, Zn and a combination thereof.

The optical disc according to one embodiment of present disclosure, the surface structures disposed on the second substrate may prevent the optical disc from sticking with each other. Moreover, the optical disc has a simple structure and is cost-effective.

### BRIEF DESCRIPTION OF THE DRAWINGS

The invention can be more fully understood by reading the following detailed description of the embodiments, with reference made to the accompanying drawings as follows:

FIG. 1 is a top view schematically illustrating an optical disc according to one embodiment of the present disclosure.

FIG. 2 is a cross-sectional view along line A-A′ in FIG. 1.

FIG. 3 is a top view schematically illustrating an optical disc according to another embodiment of the present disclosure.

FIG. 4 is a top view schematically illustrating an optical disc according to still another embodiment of the present disclosure.

FIG. 5 is a top view schematically illustrating an optical disc according to another embodiment of the present disclosure.

FIG. 6 schematically illustrates the condition of stacking up a number of the optical disc according to one embodiment of the present disclosure.

FIG. 7 is a top view schematically illustrating an optical disc according to another embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

According to embodiments of the present disclosure, a number of surface structures are employed to prevent the vacuum-liked condition, and thereby resolving the sticking problem occurred between two optic discs.

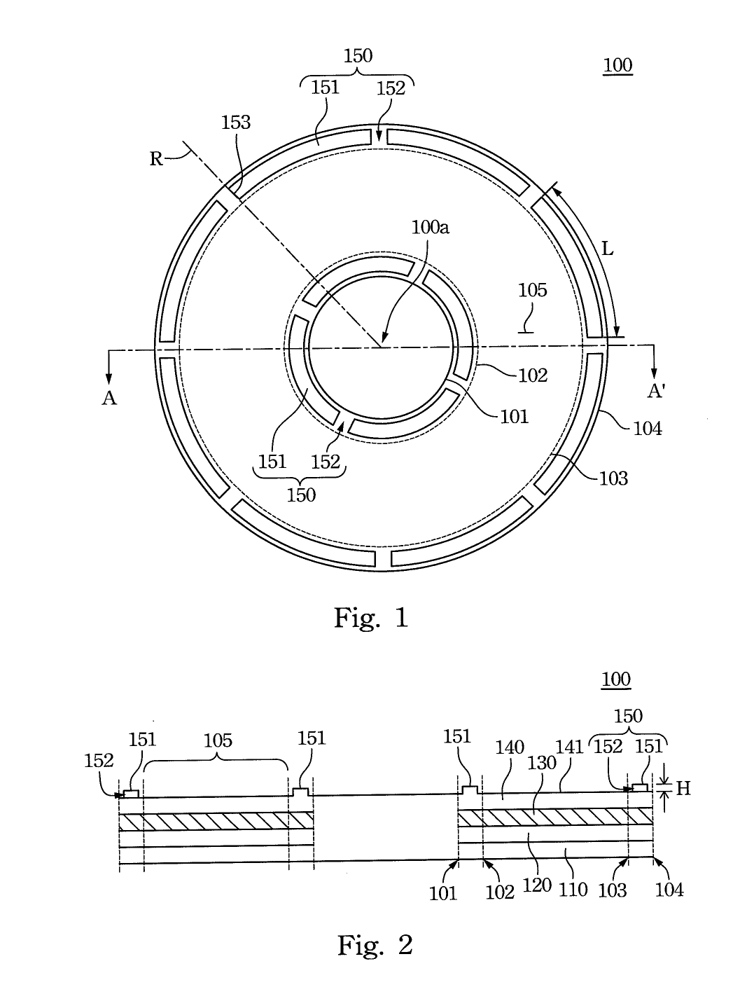

FIG. 1 is a top view schematically illustrating an optical disc according to one embodiment of the present disclosure. Referring to FIG. 1, optical disc 100 includes a central hole 100a, an internal edge 101 and an external edge 104. The internal edge 101 of the optical disc 100 surrounds the central hole 100a. The external edge 104 is the outer periphery of the optical disc 100. In practice, the diameter of the central hole and the diameter and thickness of the optical disc may satisfy the standard of audio compact disc, digital versatile disc (DVD), Blu-ray® disc or other optical storage media. In addition, the optical disc 100 may be a write once recordable compact disc or a rewritable compact disc, and the present disclosure is not limited thereto.

Specifically, the optical disc 100 has an information area 105, which is an annular region for reading or writing data. The information area 105 is situated between the internal edge 101 and the external edge 104. More specifically, the information area 105 has an inner boundary 102 and an outer boundary 103. The inner boundary 102 is in the vicinity of the internal edge 101, while the outer boundary 103 is in the vicinity of the external edge 104.

FIG. 2 is a cross-sectional view along line A-A′ in FIG. 1. Referring to FIG. 1 and FIG. 2, optical disc 100 includes a first substrate 110, a second substrate 140, a recording layer 120, a reflecting layer 130, and a plurality of surface structures 150. The second substrate 140 is disposed above the first substrate 110, and is substantially parallel to the first substrate 110. Both the recording layer 120 and the reflecting layer 130 are disposed between the first substrate 110 and the second substrate 140. The reflecting layer 130 is located between the recording layer 120 and the second substrate 140. The surface structures 150 are disposed on the surface 141 of the second substrate 140. The surface 141 is a non-reading side of the optical disc 100. The surface structures 150 are discontinuously disposed on the surface 141 of the second substrate 140, such that air may flow to the external edge 104 from the internal edge 101 through the space existing between these surface structures 150. That is, air may flow between the inner side (i.e. within the central hole 100a) and the outer side (i.e. out of the external edge 104), and the sticking problem that occurred between two adjacent optical discs due to the vacuum absorption may be prevented.

In some embodiments, the first substrate 110 may be made of polycarbonate, polymethylmethacrylate, or other material that may prevent moisture and oxygen from penetration. The second substrate 140 may also be made of polycarbonate, polymethylmethacrylate, or other material that may prevent moisture and oxygen from penetration. In one example, the surface structures 150 may be integrally formed on the second substrate 140. It is to be noted that the material of the first substrate 110 may be the same as or different from the second substrate 140, depending on the desire of the product. In practice, the recording layer 120 may be made from an organic recording material such as cyanine dye, azo dye, squarylium dye, formazan dye, and a combination thereof, and any other dye known in the art. The reflecting layer 130 may be made of silver, gold, aluminum, titanium, lead, chromium, molybdenum, tungsten, tantalum, or a combination thereof. In another example, the recording layer 120 may be made from an inorganic recording material selected from the group consisting of Si, Sn, Al, Ag, Au, Ti, Ni, Cu, Co, Ta, Fe, W, Cr, V, Ga, Pb, Mo, Sb, In, Bi, Zn and a combination thereof.

The optical disc 100 may further comprise other material layers although the embodiments described above are composed of a first substrate, a second substrate, a recording layer and a reflecting layer. For example, the optical disc may comprise a first substrate, a second substrate, a dielectric layer, an interface layer, a recording layer and a reflecting layer. The dielectric layer may be made of a material selected from the group consisting of silicon nitride, zinc sulfide-silicon dioxide, aluminium nitride, silit, nitrided germanium, titanium nitrides, tantalum oxide, yttrium oxide and a combination thereof. In addition, the optical disc disclosed herein may be applied in a relatively derived optical disc such as a digital versatile disc-dual layer (DVD-DL), a blu-ray disc-dual layer (BD DL) and a multiple-layered BD.

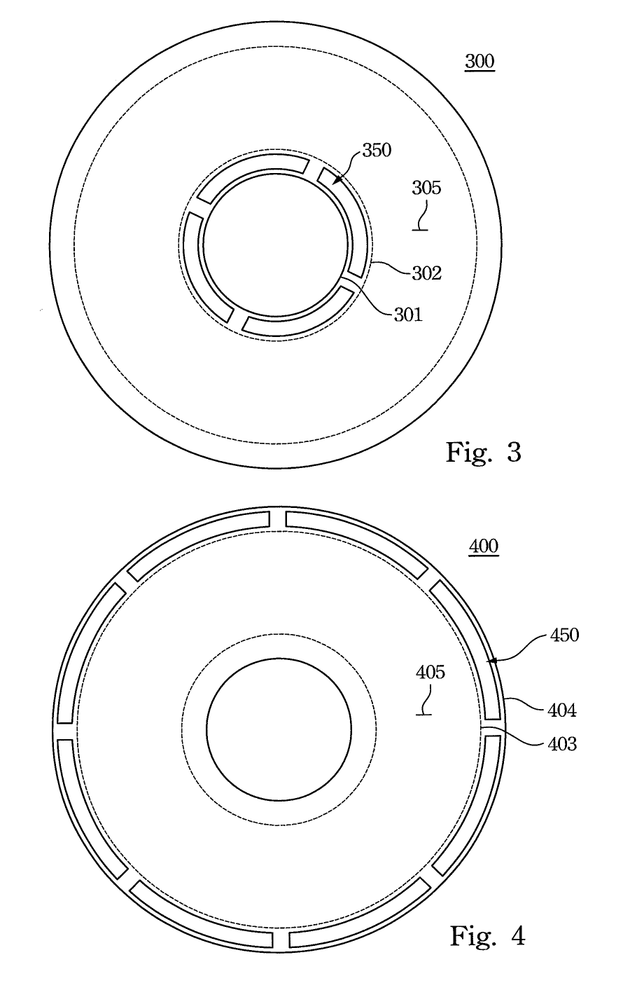

In one embodiment, the surface structures 150 of the optical disc 100 are discontinuously disposed on the surface 141 of the second substrate 140 where is out of the information area 105. Specifically, the surface structures 150 are disposed between the internal edge 101 and the inner boundary 102, and also disposed between the outer boundary 103 and the external edge 104, as illustrated in FIG. 1 and FIG. 2. However, the arrangement of the surface structures 150 is not limited to the embodiment described above. Referring to FIG. 3 and FIG. 4, FIG. 3 depicts that the surface structures 350 only exist in the vicinity of the internal edge 301. FIG. 4 depicts that the surface structures 450 only exist in the vicinity of the external edge 404. More specifically, the surface structures 350 depicted in FIG. 3 are disposed in the area that is adjacent to the internal edge 301 of the optical disc 300. That is, the surface structures 350 are disposed in the area between the internal edge 301 of the optical disc 300 and the inner boundary 302 of the information area 305. The surface structures 450 depicted in FIG. 4 are disposed in the area that is adjacent to the external edge 404 of the optical disc 400. That is, the surface structure 450 is disposed in the area between the outer boundary 403 of the information area 405 and the external edge 404 of the optical disc 400.

The present disclosure is not limited to that the surface structures 150 are discontinuously disposed on the area where is out of the information area 105. In one embodiment, the surface structures 150 may extend from a position out of the information area 105 to another position within the information area 105. Any other type of discontinuous arrangements of the surface structures 150, disposed on the surface 141 of the second substrate 140, may be applied in the present disclosure so long as air may flow between the inner side and the outer side of the optical disc 100 and prevent the sticking problem occurred between two optical discs.

Referring back to FIG. 1, the surface structures 150 includes a plurality of bumps 151, and a groove 152 is formed between two adjacent bumps 151. In this example, each of the bumps 151 substantially has a stripe shape, and the bump 151 extends along a circumferential direction of the optical disc, and thereby having a length L. In addition, each of the bumps positioned on the same circumferential direction has the same length. However, in some examples, each of the bumps may have a different length L, depending on the desire of the product.

In one specific example, each of the bumps 151 protrudes a height H from the surface 141 of the second substrate 140. The height H is about 70 μm, so that a robot would not be influenced by the bumps 151 when it grabs the optical disc 100 in the manufacturing procedure. Also, the bumps 151 would not influence the storage of the optical disc 100 in a disc box.

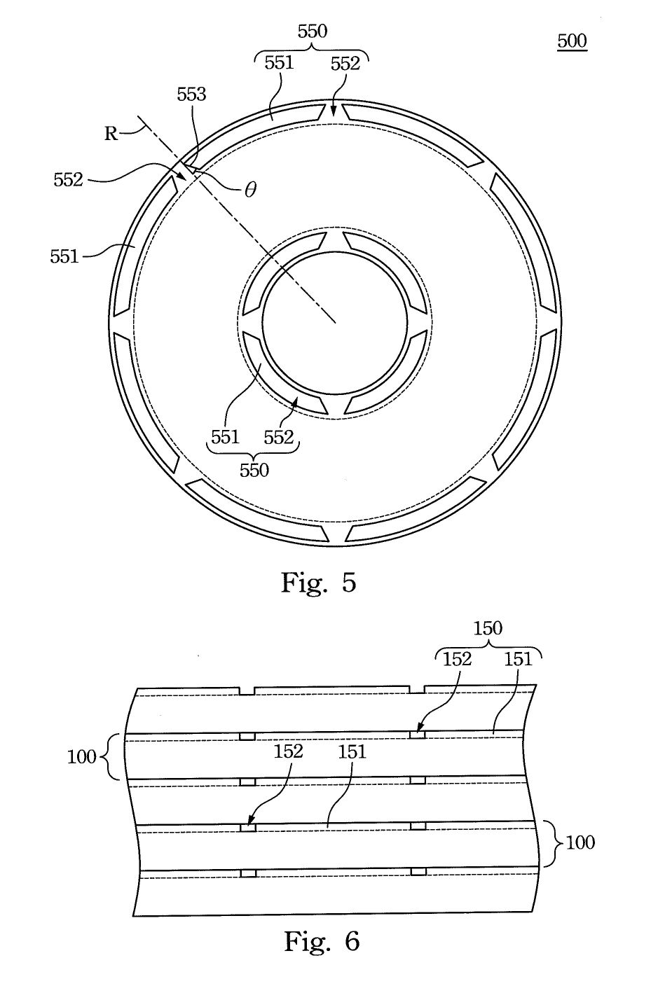

Moreover, each of the bumps 151 at least comprises a side edge 153 which faces the adjacent groove 152. The side edge 153 substantially extends on a radial direction R of the optical disc. In this way, the groove 152 extends on the radial direction R of the optical disc as well. However, the design of the bumps 151 is not limited on the way as described above. FIG. 5 is a top view schematically illustrating a different design of the bumps. Referring to FIG. 5, the optical disc 500 includes a plurality of bumps 551, and a groove 552 is formed between two adjacent bumps 551. Each of the bumps 151 includes a side edge 553 which faces the adjacent groove 552. The side edge 553 extends on a direction that forms a non-right angle θ with a radial direction of the optical disc, so that the two side of the groove 552 are not in parallel.

FIG. 6 schematically illustrates the situation of stacking up a number of the optical disc described in FIG. 1. The surface structure 150 of the optical disc 100 may include the bumps 151 discontinuously arranged and a number of grooves 152. When the optical discs 100 are stacked up, each optical disc 100 contacts with the next one by the bump 151. Air may flow between the inner side and the outer side of the optical disc 100 through the groove 152, so that the sticking problem occurred between two optical discs 100 may be prevented.

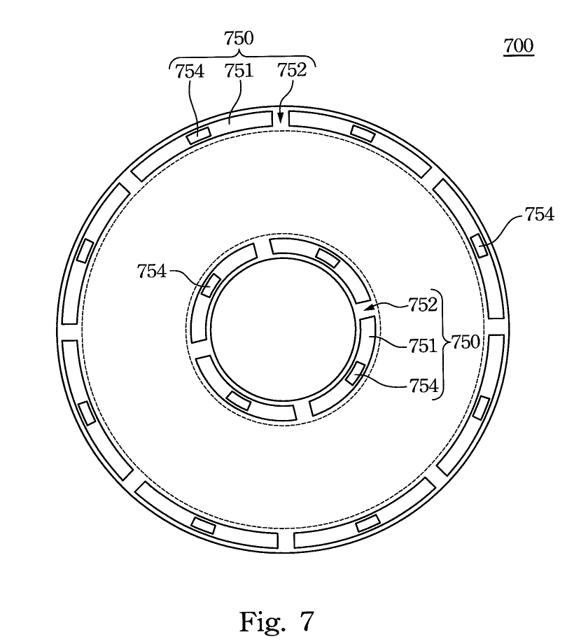

The surface structure 150 of the optical disc 100 may comprise a plurality of bumps, which are discontinuously arranged, so as to form a first profile on the surface structure. In one example, the surface structure 150 may further comprise a plurality of sub-bump to complicate the profile of the surface structure 150. FIG. 7 is a top view schematically illustrating an optical disc 700 having a plurality of sub-bumps. Referring to FIG. 7, the surface structure 750 comprises a plurality of bumps 751 and a plurality of sub-bumps 754. The sub-bumps 754 are disposed on and protrude from the bumps 751. For example, a single sub-bump 754 may be disposed on a single bump 751. Alternatively, a number of sub-bump 754 may be disposed on a single bump 751. In this way, the surface structure 750 may have a second profile, which is more complex than the first profile as depicted in FIG. 1. As a result, the sticking problem occurred between two optical discs 700, when stacking up together, may be prevented because the vacuum absorption between two optical discs 700 would not occur.

The specific detail of the surface structures 150, 350, 450, 550, 750 described above is provided for the purpose of explanation only, and is not intended to limit the present disclosure. The scope of the present disclosure covers any surface structure, disposed on the surface of the second substrate of the optical disc, for the purpose of allowing air to flow between the inner side and the outer side of the optical disc.

The optical disc disclosed herein having a surface structure, which is discontinuously disposed thereon, allows air to flow between the inner side and the outer side of the optical disc. It possesses the advantage of having a simple structure, and is cost-effective. In addition, when optical discs are stuck up together, the vacuum absorption occurred in the prior art may be prevented, and thereby resolving the sticking problem occurred between optical discs, and then the efficiency of equipment in the manufacturing process may be increased. Moreover, according to the embodiments of the present disclosure, the issue of the evaporated vapor, which disadvantageously influences the optical disc, may also be improved.

What is claimed is:

1. An optical disc having an internal edge, an external edge and an information area situated therebetween, the optical disc comprising
a first substrate;
a second substrate disposed above the first substrate;
a recording layer disposed between the first substrate and the second substrate;
a reflecting layer disposed between the first substrate and the recording layer; and
a plurality of surface structures discontinuously disposed on the surface of the second substrate.

2. The optical disc according to claim 1, wherein the information area has an inner boundary and an outer boundary, and the plurality of the surface structures are positioned between the internal edge and the inner boundary.

3. The optical disc according to claim 1, wherein the information area has an inner boundary and an outer boundary, and the plurality of the surface structures are positioned between the outer boundary and the external edge.

4. The optical disc according to claim 1, wherein the information area has an inner boundary and an outer boundary, and the plurality of the surface structures are positioned between the internal edge and the inner boundary, and positioned between the outer boundary and the external edge.

5. The optical disc according to claim 1, wherein the surface structures comprise a plurality of bumps so as to form a first profile on the surface structures, and wherein a groove is formed between two adjacent bumps.

6. The optical disc according to claim 5, wherein the surface structures further comprise a plurality of sub-bumps disposed on the plurality of bumps so as to form a second profile on the surface structures.

7. The optical disc according to claim 5, wherein each of the bumps comprises a side edge facing the adjacent groove, and wherein the side edge extends on a radial direction of the optical disc.

8. The optical disc according to claim 5, wherein each of the bumps comprises a side edge facing the adjacent groove, and wherein the side edge extends on a direction that forms a non-right angle with a radial direction of the optical disc.

9. The optical disc according to claim 5, wherein each of the bumps extends along a circumferential direction of the optical disc.

10. The optical disc according to claim 5, wherein each of the bumps protrudes from a surface of the second substrate, and has a height of about 70 μm.

11. The optical disc according to claim 1, wherein the recording layer comprises a material selected from the group consisting of cyanine dye, azo dye, squarylium dye, formazan dye, and a combination thereof.

12. The optical disc according to claim 1, wherein the recording layer comprises a material selected from the group consisting of Si, Sn, Al, Ag, Au, Ti, Ni, Cu, Co, Ta, Fe, W, Cr, V, Ga, Pb, Mo, Sb, In, Bi, Zn and a combination thereof.
